(19) United States
(12) Patent Application Publication
(10) Pub. No.: US 2007/0296123 A1
(43) Pub. Date: Dec. 27, 2007

(54) Extrusion Process

(75) Inventor: Hannu Harjuhahto, Porvoo (FI)

Correspondence Address: OLIFF & BERRIDGE, PLC, P.O. BOX 320850, ALEXANDRIA, VA, 22320-4850, US

(73) Assignee: Maillefer S.A., Ecublens (CH)

(21) Appl. No.: 11/667,291

(22) PCT Filed: Nov. 14, 2005
(86) PCT No.: PCT/FI05/50408

§ 371 Date: Jul. 18, 2007

(30) Foreign Application Priority Data
Nov. 15, 2004 (FI) 20045439

(51) Int. Cl. B29C 35/10

(52) U.S. Cl. 264/477; 425/174.4

(57) ABSTRACT

The present invention relates to preparing extruded article by flowing heat plastified stream of extrudable resinous thermoplastic material through an extrusion orifice. In the invention crosslinking additives are introduced and mixed to the surface portion of the stream of extrudable resinous thermoplastic material before the extrusion step. After the extrusion step the crosslinking of the surface portion of the extruded article provided with the crosslinking additives is initiated by special initiation means.

### FIELD OF THE INVENTION

The present invention relates to a method according to the preamble of claim 1, which is a method in a process for preparing extruded article by flowing heat plastified stream of extrudable resinous thermoplastic crosslinking material through an extrusion orifice and to a process according to preamble of claim 10 which is an extrusion process for preparing extruded article(s) in which process heat plastified stream of extrudable resinous thermoplastic crosslinking material is arranged to flow through an extrusion orifice, the process comprising the following steps, providing a source of heat plastified extrudable synthetic resinous thermoplastic crosslinking material and advancing the material along a first flow path toward the extrusion orifice. The present invention also relates to an apparatus according to preamble of claim 15, which is an apparatus for preparing extruded article(s) by flowing heat plastified stream of extrudable resinous thermoplastic crosslinking material through an extrusion orifice.

### BACKGROUND OF THE INVENTION

As known, 0the properties of polymer-based articles, including cables, profiles, films, tubes or the like, may be significantly enhanced by crosslinking the polymer-based material. In that case heat resistance, mechanical strength and chemical resistance are altered. There are various known crosslinking methods available in the industry, such as peroxide, silane and radiation based methods. In the above mentioned methods the material is fully crosslinking so that the degree of crosslinking and the crosslinking gradient in the produced article are difficult to control. Often it is desirable to create a surface layer on an extruded article so as to obtain an article having altered crosslinking properties on the surface layer in relation to the rest of the article for providing certain advantageous properties. According to the state of the art this crosslinked surface layer for an extruded article is produced by co-extruding it on the article.

This co-extrusion of the crosslinked surface layer makes the extrusion apparatus more complicated. Furthermore, a boundary surface is formed between the surface layer having altered crosslinking properties on the article and the extruded article itself. This kind of boundary surface between the crosslinked surface layer and the article is undesirable and may limit the applicability of the article.

### BRIEF DESCRIPTION OF THE INVENTION

An object of the present invention is thus to provide a method, a process and an apparatus for implementing the method to overcome the above disadvantages. The objects of the invention are achieved by a method according to the characterizing portion of claim 1 which is characterized in that the method comprises the following step,

introducing modified crosslinking additive(s) to the surface portion of the stream of extrudable resinous thermoplastic material before the extrusion step for altering the crosslinking properties of the surface portion of the extrudable material.

The objects of the invention are furthermore achieved by a process according to the characterizing portion of claim 10 which is characterized by the steps:
introducing modified crosslinking additives to the surface portion of the material flow before the extrusion step for altering the crosslinking properties of the surface portion of the extrudable material.

The objects of the present invention are also achieved by an apparatus according to the characterizing portion of claim 15 which is characterized in that apparatus comprises before the extrusion orifice (10) introducing means (8) for introducing modified crosslinking additive(s) to the surface portion of the stream of extrudable resinous thermoplastic crosslinking material for altering the crosslinking properties of the surface portion of the extrudable material.

The preferred embodiments of the invention are disclosed in the dependent claims.

The invention is based on the idea of creating an altered crosslinking surface layer in-situ extruder a part fter the melt zone by adding the modified crosslinking components/additives of the crosslinking method in question only to the surface layer of the heat plastified stream of extrudable resinous thermoplastic crosslinking material before the actual extrusion step. The result is produced an extruded article having altered crossliking properties on the surface layer in relation to the rest of the article, that is the core of the article. This way the crosslinked surface layer may be formed as an integral part of the extruded article and no separate crosslinked surface layer, for instance by co-extruding, is needed. These modified crosslinking additives may be for example reaction promoters for boosting the crosslinking reaction or they may be reaction inhibitors for decelerating the croslinking reaction. This integral crosslinked surface layer may created for example by physically separating the stream of the extrudable resinous thermoplastic material into a central core stream and at least one boundary stream on the outside of the core stream before the extrusion step, while maintaining physical separation of the core and boundary stream by selectively introducing crosslinking additive(s) to the boundary streams and thereafter recombining the streams prior expelling the material in the extrusion step out of the extrusion orifice, said boundary streams being applied as a relatively thin surface layer having altered crosslinking properties between the core layer and the surfaces of the extrusion orifice. The surface layer having altered crosslinking properties is thus created as an integral surface layer during normal extrusion. Other parts of the article except the surface layer may also be crosslinked during the extrusion process, but because of the crosslinking additive supplied on the surface of the article, the crosslinking structure of the surface layer is different than the structure of the other parts of the article. Another way is to apply the modified crosslinking additives directly on the surface of the heat plastified stream of the extrudable resinous thermoplastic crosslinking material.

An advantage of the present invention is that this kind of integral surface layer having altered crosslinking properties in relation to other parts or the core of the extruded article provides a mechanically stronger surface. Additionally the invention also enables better ultraviolet radiation protection, thermal stabilization and combinations of colouring and filling agents. Also the degree of the crosslinking and the crosslinking density may be controlled more precisely and the surface and the core of the extruded article may have altered crosslinked structures while being integral parts.

### BRIEF DESCRIPTION OF THE DRAWINGS

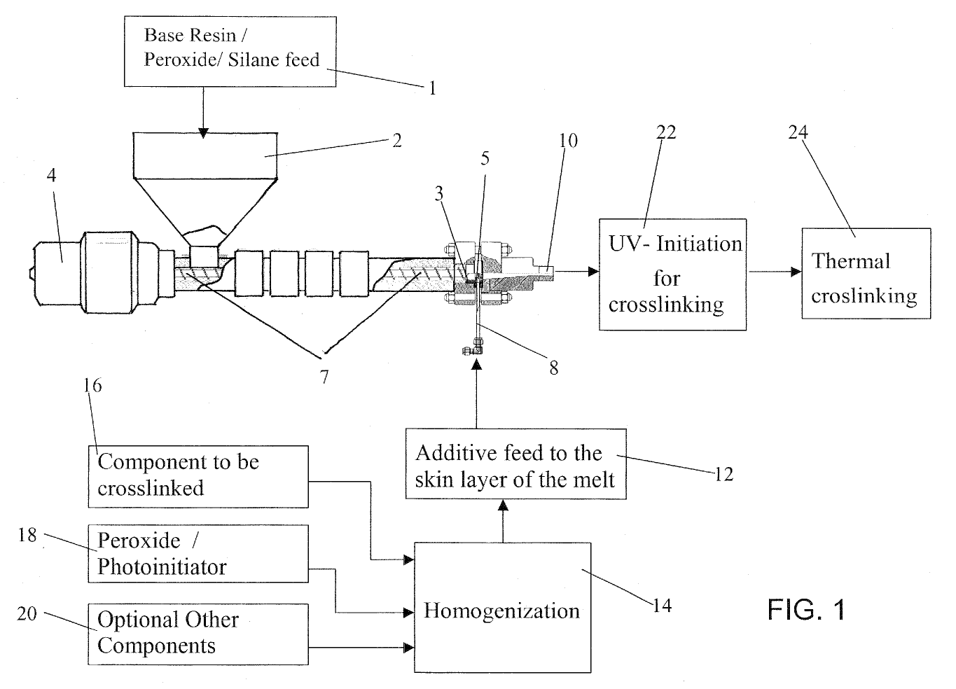

In the following the invention will be described in greater detail by means of preferred embodiments with reference to the accompanying drawings, in which FIG. 1 is a schematic view of an extrusion method and apparatus according to the present invention.

### DETAILED DESCRIPTION OF THE INVENTION

According to one embodiment of the invention the modified crosslinking additive or additives is applied through an extrusion orifice on the surface of the heat plastified stream of extrudable resinous thermoplastic crosslinking material before the actual extrusion step. In that case the modified crosslinking additive spreads on the resinous crosslinking material to form a surface layer having altered crosslinking properties in relation to the rest of the resinous material to be extruded. Therefore also the extruded article comprises a surface layer having altered crosslinking properties. This applying of the modified crosslinking additive is carried out using introducing means. After the actual extrusion step the crosslinking of the surface layer having altered crosslinking properties is initiated using initiation means, the crosslinking of the surface layer and the crosslinking of other parts of the extruded article being then continued using conventional crosslinking means. This way the crosslinking of the core part of the extruded article may be controlled by altering the crosslinking of the surface layer. The modified crosslinking additive may be in the form of reaction promoters for example for boosting the crosslinking reaction or they may be reaction inhibitors for decelerating the crosslinking reaction.

FIG. 1 shows a schematic view of the apparatus and method according to another embodiment of the present invention. The features described with this embodiment are also applicable with the above mentioned embodiment. The method in a process for preparing extruded article by flowing heat plastified stream of an extrudable resinous thermoplastic material through an extrusion orifice comprises separating the stream of an extrudable resinous thermoplastic material into a central core stream and at least one boundary stream on the outside of the core stream.

While maintaining the physical separation of the core and boundary streams, crosslinking additive(s) are selectively introduced to the boundary streams. These crosslinking additives comprise at least one component to be crosslinked. They may also comprise crosslinking initiators and optionally other reactive components. These components and initiators are mixed and the thus formed additive is homogenized. The crosslinking additive is then selectively introduced and mixed to the boundary stream prior to the extrusion orifice. The boundary stream and the core stream are further recombined prior to expelling the material out of the extrusion orifice so that the boundary stream forms the outer layer of the recombined stream, the boundary stream being applied as a relatively thin surface layer having altered crosslinking properties between the core layer and the surfaces of the extrusion orifice. The resinous material of the recombined stream is then expelled through the extrusion orifice so as to prepare an extruded article in which the surface layer of the recombined stream forms the outer layer of the extruded article having altered crosslinking properties.

After the extrusion step the crosslinking of the surface layer of the extruded article is initiated using initiation means, for instance ultraviolet initiation means. The initiation means activate the crosslinking initiators so that crosslinking of the surface layer having these crosslinking additives begins. After the initiation of crosslinking the crosslinking may then continue as conventional thermal crosslinking. This thermal crosslinking may be carried out by thermal bath, infra red radiation or the like method. This thermal crosslinking may also carry out the crosslinking of other parts than the surface layer of the extruded article. In that case the surface layer and the other parts of the extruded article have different crosslinked structures.

Properties of the surface layer of the extruded article may be modified as desired by controlling the initiation means to initiate the crosslinking of the surface layer of the extruded article, by for instance ultraviolet radiation intensity of the ultraviolet initiator. These properties may also be modified controlling the duration and temperature of the thermal crosslinking. Another possibility for modifying the crossliking properties of the surface layer of the extruded article is to vary the composition of the crosslinking additive to be fed into the boundary stream. This composition of the crosslinking additive may be accomplished by selecting a suitable component to be crosslinked, a suitable crosslinking initiator and a suitable amount and proportion of components and initiators. Suitable initiators are such as peroxide, silane and photo initiators. Other optional functional components may also be added to the crosslinking additive to be homogenized for altering the properties of the material for forming the surface layer of the stream of the extrudable resinous thermoplastic material and/or the surface layer of the extruded article.

The present invention also relates to an extrusion process for preparing an extruded article or articles in which process an heat plastified stream of an extrudable resinous thermoplastic material is arranged to flow through an extrusion orifice. In the process there is provided a source of heat plastified extrudable synthetic resinous thermoplastic material such as base resin, peroxide or silane material or a combination thereof. In the process this extrudable material is advanced along a first flow path toward the extrusion orifice. Before the extrusion orifice a portion of the material is diverged from the first flow path to a second flow path forming a boundary flow path outside the first flow path.

After diverging of the second flow path from the first flow path, crosslinking additives are introduced and mixed into the diverted flow, that is the second flow path. After introducing and mixing of the additives to the second flow path, the first and second flow paths are recombined so that the second flow path comprising the crosslinking additives forms the surface portion of the recombined flow in the first flow path. This way the crosslinking material is applied as a relatively thin layer to the surface of the resin flowing in the first flow path, prior to passing the material through the extrusion orifice.

This recombined flow having a surface portion comprising altered crosslinking properties is then passed through an extrusion orifice so as to perform the extrusion step. The extruded article thus has a surface layer having altered crosslinking properties because of the crosslinking additive. After the extrusion step the crosslinking of the surface portion of the extruded article provided with the crosslinking additive is initiated. This initiation of the crosslinking of the surface portion of the extruded article is may be performed for instance by ultraviolet radiation. The crosslinking is then continued by conventional thermal crosslinking so as to achieve a desired crosslinking gradient and/or degree of crosslinking of the surface portion of the article and/or the other parts of the article.

Before applying the crosslinking additive to the diverted flow it is homogenized since it may contain several components including components to be crosslinked, crosslinking initiators and/or other optional reactive components.

An embodiment of an apparatus for performing the method and procedure of the present invention is shown schematically in FIG. 1. The apparatus according to the present invention for preparing an extruded article by arranging a heat plastified stream of extrudable resinous thermoplastic material to flow through an extrusion orifice 10 comprises a source of extrudable material 1, such as a base resin, peroxide or silane, a feed hopper 2, driving means 4 and screw means 7 for conveying the extrudable material towards the extrusion orifice 10. Before the extrusion orifice 10 there is provided first means 3 for physically separating the stream into a central core stream and at least one boundary stream outside of the core stream and third means 5 for recombining the streams prior to expelling the material out of the extrusion orifice 10. Between the first means 3 and third means 5 there is arranged introducing means 8 for selectively introducing crosslinking additives to the surface portion of the stream of the stream of extrudable resinous thermoplastic material, that is to the boundary stream. The said boundary streams are applied as a relatively thin surface layer having altered crosslinking properties between the core layer and the surfaces of the extrusion orifice.

By the third means 5 the recombined streams are then passed through the extrusion orifice 10. After extrusion of the article through the extrusion orifice 10 the crosslinking of the surface layer of the extruded article is initiated by initiation means 22. These initiation means 22 may be for example an ultra-violet radiation source. After the initiation of the crosslinking of the surface layer comprising a crosslinking additive, the crosslinking may be continued by thermal crosslinking means 24.

The apparatus according to the embodiment of the invention further comprises a source of a component to be crosslinked 16, a source of crosslinking initiator 18 and a source of other optional components 20 which together form the crosslinking additive. These components and initiators are then supplied to homogenizing means 14 for homogenizing the crosslinking additive before introducing it to the surface portion of the stream of extrudable resinous thermoplastic material. The homogenizing means 14 may be a mixer or the like apparatus for homogenizing the additive consisting of component to be crosslinked and crosslinking initiator and/or other optional reactive components. In addition there is provided a source of additive 12 for supplying the homogenized additive to the introducing means 8 and further to the surface portion of the stream of the stream of the stream of extrudable resinous thermoplastic material.

The apparatus may also comprise a source of an extrudable material, such as a base resin, peroxide or silane, a feed hopper, driving means and screw means for conveying the extrudable material towards the extrusion orifice. Before the extrusion orifice there is arranged introducing means for selectively introducing crosslinking additives to the surface portion of the stream of the stream of extrudable resinous thermoplastic material. After extrusion of the article through the extrusion orifice the crosslinking of the surface layer of the extruded article is initiated by initiation means. These initiation means may be for example an ultra-violet radiation source. After the initiation of crosslinking of the surface layer comprising crosslinking additive, the crosslinking may be continued by thermal crosslinking means. In addition this embodiment of the apparatus may also comprise homogenizing means 14 for homogenizing the crosslinking additive before introducing it to the surface portion of the stream of the stream of extrudable resinous thermoplastic material.

It will be obvious to a person skilled in the art that, as technology advances, the inventive concept can be implemented in various ways. The invention and its embodiments are not limited to the examples described above but may vary within the scope of the claims. For example the initiation means 22 may be selected according to the initiator supplied to the crosslinking additive. When using photo initiator the initiation means 22 may be a ultra violet radiation source for initiating the crosslinking of the surface layer provided with photo initiators.

1-17. (canceled)

18. Method in a process for preparing extruded article(s) by flowing a heat plastified stream of extrudable resinous thermoplastic crosslinkable material through an extrusion orifice, the method comprising introducing modified crosslinking additive(s) to the surface portion of the stream of extrudable resinous thermoplastic crosslinkable material before the extrusion step for altering the crosslinking properties of the surface portion of the extrudable material wherein the method further comprises, after the extrusion step, the initiating of the crosslinking of the surface portion of the extruded article(s) provided with the modified crosslinking additive(s) by ultra-violet radiation.

19. A method according to claim 18, wherein it further comprises the following step carried out before introducing modified crosslinking additive(s) to the surface portion of the stream of extrudable resinous thermoplastic crosslinking material:
homogenizing the modified crosslinking additive(s) comprising at least the component(s) to be crosslinked and/or crosslinking initiator(s).

20. A method according to claim 18, wherein the crosslinking initiator is selected from a group consisting of peroxide(s), silane(s) and photo initiator(s).

21. A method according to claim 18, wherein it also other functional components are added to the modified crosslinking additive to be homogenized for altering the properties of the material forming the surface layer of a stream of extrudable resinous thermoplastic crosslinking material.

22. A method according to claim 18, wherein further comprises a step of selecting the additive and the amount of additive.

23. A method according to claim 18, wherein it further comprises the following step carried out after the initiation of the crosslinking of the surface layer of the extruded article:
continuing the crosslinking of the surface layer of the extruded article or the whole article with a thermal crosslinking using predetermined temperature and for a predetermined time for forming a desired crosslinked structure for the surface layer of the extruded article and/or the whole article.

24. A method according to claim 18, wherein the step of introducing modified crosslinking additive(s) to the surface portion of the stream of extrudable resinous thermoplastic crosslinking material before the extrusion step comprises the steps:
physically separating the stream of extrudable resinous thermoplastic crosslinkable material into a central core stream and at least one boundary stream on the outside of the core stream;
while maintaining physical separation of the core and boundary stream, selectively introducing modified crosslinking additive(s) to the boundary streams; and thereafter
recombining the streams prior to expelling the material out of the extrusion orifice, said boundary streams being applied as a relatively thin surface layer having altered crosslinking properties between the core layer and the surfaces of the extrusion orifice.

25. An extrusion process for preparing extruded article(s) in which process a heat plastified stream of extrudable resinous thermoplastic crosslinkable material is arranged to flow through an extrusion orifice, the process comprising the following steps;
providing a source of heat plastified extrudable synthetic resinous thermoplastic crosslinkable material;
advancing the material along a first flow path towards the extrusion orifice,
introducing one or several modified crosslinking additives to the surface portion of the material flow before the extrusion step for altering the crosslinking properties of the surface portion of the extrudable material,
comprising a step of launching the crosslinking of the surface portion of the extruded article(s) provided with the modified crosslinking additive(s) by ultra violet radiation after the extrusion step.

26. The extrusion process according to claim 25, wherein the crosslinking is completed with ultra-violet radiation of the surface portion of the extruded article(s).

27. The extrusion process according to claim 25, wherein it further comprises steps of:
diverting a portion of material from a first flow path to a second flow path and introducing modified crosslinking additive(s) to the diverted flow; and
applying the modified crosslinking material as a relatively thin layer to the surface of the resin flowing in the first flow path prior to passing the material through the extrusion orifice.

28. The extrusion process according to claim 25, wherein it further comprises a step of:
homogenizing the modified crosslinking additive(s) comprising at least a component(s) to be crosslinked and/or crosslinking initiator(s) before introducing it to the surface portion of the material flow.

28. The extrusion process according to claim 25, wherein it further comprises a step of:
continuing the crosslinking of the surface portion of the extruded article or the whole article with a thermal crosslinking.

29. An apparatus for preparing extruded article(s) by flowing heat plastified stream of extrudable resinous thermoplastic crosslinkable material through an extrusion orifice, the apparatus comprising upstream of the extrusion orifice (10) introducing means (8) for introducing modified crosslinking additive(s) to the surface portion of the stream of the stream of extrudable resinous thermoplastic crosslinkabel material for altering the crosslinking properties of the surface portion of the extrudable material, wherein the apparatus further comprises an ultra-violet radiation source for initiating the crosslinking of the surface layer of the extruded article(s) downstream the extrusion orifice (10).

30. The apparatus according claim 29, wherein the ultra-violet radiation source is arranged such that the crosslinking of the surface portion of the extruded article(s) is completed with ultra-violet radiation.

31. The apparatus according claim 29, wherein it further comprises homogenizing means (14) for homogenizing the modified crosslinking additive(s) before introducing it to the surface portion of the stream of the stream of extrudable resinous thermoplastic material.

32. The apparatus according to claim 29, wherein it further comprises thermal crosslinking means (24) continuing the crosslinking of the surface layer of the extruded article or the whole article after the initiation of the crosslinking with the initiation means (22).

33. The apparatus according to claim 29, wherein the apparatus further comprises first means (3) for physically separating the stream into a central core stream and at least one boundary stream on the outside of the core stream, that the introducing means (8) is arranged to introduce modified crosslinking additive(s) to the boundary streams while maintaining physical separation of the core and boundary streams and that the apparatus further comprises third means (5) for recombining the streams prior to expelling the material out of the extrusion orifice, said boundary streams being applied as a relatively thin surface layer having altered crosslinking properties between the core layer and the surfaces of the extrusion orifice.
